(19) United States
(12) Patent Application Publication
(10) Pub. No.: US 2014/0088208 A1
(43) Pub. Date: Mar. 27, 2014

(54) EXPANDED IONOMERS AND THEIR USES

(71) Applicant: EXONOMER PTY LTD, BLACKBURN SOUTH (AU)

(72) Inventors: Alastair M. Hodges, Blackburn South (AU); Garry Chambers, Melbourne (AU)

(73) Assignee: EXONOMER PTY LTD, BLACKBURN SOUTH (AU)

(21) Appl. No.: 14/119,771

(22) PCT Filed: May 23, 2012
(86) PCT No.: PCT/IB2012/001115

§ 371 Date: Nov. 22, 2013

Related U.S. Application Data
(60) Provisional application No. 61/489,132, filed on May 23, 2011.

(51) Int. Cl. B01J 39/18

(52) U.S. Cl. CPC B01J 39/185
USPC 521/28; 521/25; 521/30

(57) ABSTRACT

Disclosed herein are expanded ionomer materials including a plurality of voids. Also disclosed are methods of making and using the expanded ionomer materials.

### BACKGROUND

Ionomers are organic polymers that contain permanently charged groups such as sulphonic acid groups, carboxylic acid groups, ammonium groups and the like. Ionomers have many uses, for example, as ion exchange resins, catalysts and to make membranes with selective ion transport properties. An exemplary ionomer is Nafion®—a perfluorinated sulphonic acid polymer from DuPont—due to its chemical inertness, highly selective proton transport and super acid catalyst properties. The disadvantages of many ionomers, including Nafion®, are the restricted ways they can be processed. For example, fluoropolymer ionomers tend to be very tough materials that are difficult to process. In addition, it is difficult to produce powders from polymers such as Nafion® with existing commercially available forms typically requiring extended milling times under cryogenic conditions.

Another issue with ionomers, such as Nafion®, in their prior art forms in some applications is that they are relatively dense materials. For example, when using ionomers as polymer electrolytes in fuel cells and electrolysis cells it is desirable that the ionomer has a low resistance to ion flow to reduce the internal electrical resistance of the cells. One cause of a higher than desirable electrical resistance in ionomers is the limited concentration of fixed charges and their corresponding mobile ions. There have been many attempts to introduce more fixed charges into ionomers, such as Nafion®, by filling the ionomer with another material with fixed charges, such as solid Bronsted acids, for example zirconium phosphate, however these have been largely unsuccessful in lowering the ionomer resistance. This lack of improvement, despite the successful incorporation of additional fixed charges, can be due to the added material blocking or impeding the existing ion flow paths. Another problem encountered when using ionomers as ion conductors, such as in fuel cells, is that they need to be well hydrated to give low electrical resistance. Silica and other hygroscopic solid fillers have been incorporated into ionomers in an effort to retain water longer in the materials.

Embodiments of the invention disclosed herein include a novel form of a solid ionomer that can lead to an improvement in its processability, while preserving or enhancing its ion exchange properties, thereby allowing it to retain more water and/or allowing it to be filled with additional material(s) with less blockage of an existing ion flow path.

### SUMMARY

Some embodiments of the invention disclosed herein include an expanded ionomer material including an ionomer and a plurality of voids, wherein a porosity of the expanded ionomer material is higher than a porosity of the pre-expanded ionomer material. The ionomer can include at least one polymer selected from, for example, sulphonated polystyrene, carboxylated polystyrene, amminated polystyrene, a sulphonated fluoropolymer, carboxylated fluoropolymer, and amminated fluoropolymer, and the like. The voids can include spheroids with diameters in the range of 10 microns to 100 microns. In some embodiments, the porosity of the expanded ionomer material is higher than the porosity of the pre-expanded ionomer material by at least 5%, preferably by at least 10%, and more preferably by at least 20%. In some embodiments, the porosity of the expanded ionomer material is at least 30%, or at least 40%, or at least 50%. In some embodiments, at least some voids can contain a modifying component. The modifying component can include one material selected from, for example, silica, a solid acid, a catalytic material, and the like. The solid acid can include, for example, a zirconium phosphate, or the like. The catalytic material can include, for example, a metal, a metal oxide, or the like. The metal can include at least one metal selected from, for example, platinum, palladium, ruthenium, iridium, copper, nickel, and the like. The metal oxide can include at least one material selected from, for example, titania, alumina, zirconia, and the like. At least some voids can contain more than one modifying component. The expanded ionomer material can have a configuration selected from, for example, a block, a sheet, a pellet, a bead, a powder, and the like.

Some embodiments of the invention include a method for modifying an ionomer material including providing an ionomer in a solid state; contacting the ionomer with a vaporisable substance to form a pre-expanded ionomer material; and heating the pre-expanded ionomer material to vaporise the vaporisable substance to create voids in the ionomer material thereby producing an expanded ionomer material. The method can be suitable for modifying an ionomer selected from, for example, a sulphonated polystyrene, a carboxylated polystyrene, an amminated polystyrene, a sulphonated fluoropolymer, a carboxylated fluoropolymer, an amminated fluoropolymer, and the like. Contacting the ionomer with a vaporisable substance can include, for example, storing the ionomer in air at ambient humidity or impregnating the ionomer with the vaporisable substance. Impregnating the ionomer with the vaporisable substance can be achieved by, for example, dipping the ionomer in the vaporisable substance, spraying the vaporisable substance on to the ionomer, soaking the ionomer in the vaporisable substance, or another similar method, or a combination thereof. In using these methods it can be desirable to remove excess vaporisable substance from the surface of the pre-expanded ionomer material before subsequent treatment, for example, prior to subsequent heating treatment.

In some embodiments, the vaporisable substance can include a polar aprotic liquid. In some embodiments, the polar aprotic liquid can include at least one liquid selected from, for example, water, an alcohol, dimethylformamide, dimethylsulfoxide, acetonitrile, and the like. In some embodiments, the polar aprotic liquid can include a dipolar aprotic liquid.

The heating the pre-expanded ionomer material can include a mechanism such as, for example, blowing heated air on to the pre-expanded material, passing the pre-expanded material through a hot zone in an oven followed by a cooling zone, exposing the pre-expanded material to infrared radiation, and applying microwave energy to the pre-expanded material, or the like. The voids in the expanded ionomer material can include spheroids with diameters in the range of 10 microns to 100 microns. In some embodiments, the porosity of the expanded ionomer material can be higher than the porosity of the ionomer by at least 5%, preferably by at least 10%, and more preferably by at least 20%. In some embodiments, the porosity of the expanded ionomer material can be higher than the porosity of the ionomer by at least 5%, preferably by at least 10%, and more preferably by at least 20%. In some embodiments, the porosity of the expanded ionomer material is at least 30%, or at least 40%, or at least 50%.

In some embodiments, the method can further include depositing a modifying component within at least some of the voids. The modifying component can include a material selected from, for example, silica, a solid acid, a catalytic material, and the like. The solid acid can include, for example, a zirconium phosphate, or the like. The catalytic material can include, for example, a metal, a metal oxide, or the like. The metal can include at least one metal selected from, for example, platinum, palladium, ruthenium, iridium, copper, nickel, and the like. The metal oxide can include at least one material selected from, for example, titania, alumina, zirconia, and the like. The method can include depositing more than one modifying components within at least some of the voids.

In some embodiments, the expanded ionomer material has a configuration selected from a block, a sheet, a membrane, a pellet, a bead, and a powder. The method can further include processing the expanded ionomer material to form a configuration selected from a block, a sheet, a membrane, a pellet, a bead, and a powder. The processing the expanded ionomer material can include, for example, using mechanical grinding. The mechanical grinding can include, for example, using a blade grinder, a ball mill, and the like. The processing the expanded ionomer material can produce a powder.

Some embodiments of the invention include a method of using an expanded ionomer material. Some embodiments of the invention include a method of using an expanded ionomer material in the configuration of, for example, a block, a sheet, a membrane, a pellet, a bead, and a powder. In some embodiments, an expanded ionomer material in the form of a membrane or sheet can be used in applications such as a fuel cell or an electrolyser. In some embodiments, an expanded ionomer material is used as a catalytically active structure. For example, one or more catalysts can be deposited within the voids of the expanded ionomer.

Some embodiments of the invention include a method of using powder generated from the expanded ionomer. The powder can be processed by, for example, sintering or melting, to form a membrane or a macroporous block. The membrane or a macroporous block can be used in applications such as fuel cells and electrolysers or as a catalytically active structure.

### BRIEF DESCRIPTION OF THE DRAWINGS

FIG. 1 shows an ion exchange curve for pre-expanded and expanded N117. +'s denote data for pre-expanded Nafion® N117 (“N117”), and x's denote data for heat treated (expanded) Nafion® N117 (“Expanded N117”).

FIG. 2 shows a first order kinetic plot of ion exchange data for pre-expanded and expanded N117. +'s denote data for pre-expanded Nafion® N117 (“N117”), and x's denote data for heat treated (expanded) Nafion® N117 (“Expanded N117”).

FIG. 3 shows the overall ion exchange kinetics of pre-expanded and expanded Nafion® NR50. x's denote data for pre-expanded Nafion® NR50 (“NR50”), and *'s denote data for heat treated (expanded) Nafion® NR50 (“Ex NR50”).

FIG. 4 shows the initial ion exchange kinetics of pre-expanded and expanded Nafion® NR50. x's denote data for pre-expanded Nafion® NR50 (“NR50”), and *'s denote data for heat treated (expanded) Nafion® NR50 “Ex NR50”).

FIG. 5 shows an impedance versus frequency plot for pre-expanded N117 (the top curve, “N117”) and expanded N117 (the bottom curve, “Ex N117”) in the acid form.

FIG. 6 shows the capacitance versus frequency plot for pre-expanded N117 (the bottom curve, “N117”) and expanded N117 (the top curve, “Ex N117”) in the acid form.

FIG. 7 shows the impedance versus frequency plot for pre-expanded N117 (the top curve with a spike, “N117”) and expanded N117 (the bottom curve, “Ex N117”) in the sodium form.

FIG. 8 shows the capacitance versus frequency plot for pre-expanded N117 (the bottom curve, “N117”) and expanded N117 (the top curve, “Ex N117”) in the sodium form.

FIG. 9 shows the real part of the impedance versus time, using a 1 Mhz, 10 mV AC signal, for pre-expanded and heat treated (expanded) Nafion® 117. The +'s indicate data for the pre-expanded N117 (“N117”) and the x's data for the heat treated (expanded) N117 (“Ex N117”).

### DETAILED DESCRIPTION

In some embodiments, the numbers expressing quantities of ingredients, properties, such as molecular weights, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Due to the presence of charged groups in an ionomer material, it can contain a significant amount of water when in a solid form, even when stored in air at ambient humidity. It can also be impregnated with other polar or non-polar liquid(s). In some embodiments of the invention, heat is applied rapidly to the ionomer. This can cause the liquid in the polymer to vaporise. The resulting rapid formation of gas within the polymer can cause formation of a material containing multiple voids throughout the material, thus expanding the material, reducing its overall density and forming expanded passages for access of liquids and gases to the depth of the material. The resulting material is referred to herein as the “expanded ionomer,” or “expanded form,” or “expanded ionomer material,” or “structure,” and the original material referred to as the “ionomer,” or “ionomer material,” or “pre-expanded ionomer material,” or “native, untreated ionomer,” or “unaltered ionomer.” In some embodiments, the term “ionomer” and the term “pre-expanded ionomer material” are used interchangeably. In some embodiments, a pre-expanded ionomer material refers to an ionomer after it is contacted with a substance, e.g., a vaporisable substance.

As used herein, a solid material, unlike a liquid or gas, refers to a substance that does not flow perceptibly under moderate stress. A solid material can be rigid or flexible, and can have voids (e.g., voids whose size is in the order of angstroms to microns to larger).

The resulting material produced by the methods disclosed herein (i.e., the expanded ionomer) can be useful in a number of ways. In some applications, it can improve access of a liquid(s) and/or gas(es) to the depth of the ionomer material, and can enhance its catalytic activity when the ionomer is used as a catalyst. As well as providing improved access, the created voids can be used to incorporate additional filler material(s) (modifying component(s)) without substantially impeding the ion flow paths through the polymer structure. Thus, one or more functional materials (modifying component(s)) can be introduced into the expanded material without degrading its basic ion exchange and ion conduction properties. Additionally, the expansion can decrease the toughness of the ionomer material, improving the ability to process it into other configurations, for example, powder, pellets, beads, or the like, which can be used as is, for example, as a catalyst with high surface area, or further processed into another configuration using one or more known processing techniques, such as, hot pressing and/or sintering. For example, Nafion® that has undergone a heating and expansion treatment according to embodiments of the invention disclosed herein can conveniently be processed into a powder using a conventional grinder in a matter of minutes. This powder can be used as is, or further processed into other configuration(s) using a known method such as hot pressing and/or sintering. In some embodiments, the powder can be used in conjunction with a solution of ionomer to form an ionomer membrane.

In some embodiments, the expanded forms disclosed herein demonstrate similar or better ion exchange kinetics and essentially the same ion exchange capacity as the original material (unaltered ionomer), but contained in a more open structure. The expansion treatment disclosed herein can also lead to increased charged group mobility, increased liquid content and/or increased liquid permeability, useful in catalyst applications of the ionomer.

An additional benefit of the open structure of the expanded form is that the voids can be used as repositories for other filler material(s) (modifying component(s)) that can be incorporated without detrimental blockage of the ion or liquid flow path(s). This can be relevant to using an ionomer as a polymer electrolyte in a fuel cell or as a compound catalyst. In the former application, for example, the filler (modifying component(s)) can incorporate additional fixed charges that can lead to an increase in the concentration of charge carriers in the filled expanded ionomer material, or the filler (modifying component(s)) can be a hygroscopic material that can help retain water in the expanded ionomer, improving ion mobility in the material. In the latter application, for example, the filler (modifying component(s)) can be used to incorporate one or more catalyst types in the material, that can work alone or in conjunction with one or more ionomer acid catalyst sites to perform the desired chemical reaction(s), forming a single solid catalyst structure that can contain multiple catalytic functionalities while being easily separable from the other reaction component(s) when desired.

Some embodiments of the invention are drawn to an expanded ionomer material including an ionomer and a plurality of voids, wherein a porosity of the expanded ionomer material is higher than a porosity of the pre-expanded ionomer material.

A suitable ionomer can absorb a sufficient amount of a liquid (vaporisable substance) that can vaporise at a temperature when the ionomer (a polymer material) is sufficiently soft to be able to expand. The liquid (vaporisable substance) can be water due to its natural presence in ionomers, its cost and chemical safety; however, any other liquid with a vaporisation temperature tailored to the ionomer softening properties that can be absorbed by the ionomer can also be used.

Examples of suitable ionomers include, for example, sulphonated polystyrene, carboxylated polystyrene, amminated polystyrene, a sulphonated fluoropolymer, carboxylated fluoropolymer, amminated fluoropolymer, and the like. Some embodiments of the invention are suitable for a sulphonated fluoropolymer, such as Nafion®, due to its high utility and difficulty of processing in the form supplied by the prior art.

The voids within the expanded ionomer material can include spheroids with diameters in the range of 10 microns to 100 microns. The voids can include spheroids with diameters larger than 100 microns, or 150 microns, or 200 microns, or 250 microns, or 300 microns. The voids can include spheroids with diameters smaller than 10 microns. The voids can have shapes other than spheroids.

The porosity of the expanded ionomer material can be higher than the porosity of the pre-expanded ionomer material (i.e., native, untreated, unaltered ionomer) by at least 5%, or at least 10%, or at least 20%, or at least 30%, or at least 40%. In some embodiments, the porosity of the expanded ionomer material can be at least 20%, or at least 30%, or at least 40%, or at least 50%, or at least 60%, or at least 70%, or at least 80%. The increase in the porosity of the expanded ionomer material can be due to the expansion of the native, untreated ionomer.

The expanded ionomer material can further include a modifying component contained within at least some of the voids. The modifying component(s) can be designed to enhance the functional properties of the composite material. For example, the deposited modifying component can be silica, which is hygroscopic and thus can help retain water within the expanded material. In some embodiments, the deposited modifying component can be a solid acid, such as a zirconium phosphate, which can increase the concentration of fixed and mobile ions in the material. In some embodiments, the deposited modifying component can have a catalytic surface for carrying out chemical reactions. Examples of catalytic materials include, for example, a metal such platinum, palladium, ruthenium, iridium, copper, nickel, and the like, a metal oxide such as titania, alumina, zirconia, and one or more other solid materials with the desired catalytic properties. In some embodiments, more than one type of modifying components can be deposited to achieve the desired functionality of the expanded ionomer material.

Some embodiments of the invention include a method for modifying an ionomer material, the methods including providing an ionomer in a solid state, contacting the ionomer with a vaporisable substance to form a pre-expanded ionomer material; and heating the pre-expanded ionomer material to vaporise the vaporisable substance to create voids in the ionomer material thereby producing an expanded ionomer material.

The methods disclosed herein can be suitable for modifying a ionomer material including, for example, sulphonated polystyrene, carboxylated polystyrene, amminated polystyrene, a sulphonated fluoropolymer, carboxylated fluoropolymer, and amminated fluoropolymer, and the like. It is understood that the methods disclosed herein can be used to process other materials to form expanded materials with increased porosity.

In some embodiments, the methods disclosed herein can include contacting the ionomer with the vaporisable substance to form a pre-expanded ionomer material. This can be achieved by, for example, storing the pre-expanded ionomer material in air at ambient humidity, impregnating the pre-expanded ionomer material with the vaporisable substance, or the like, or a combination thereof. Impregnating the pre-expanded ionomer material with the vaporisable substance can be achieved by, for example, dipping the pre-expanded ionomer material in a vaporisable substance, spraying a vaporisable substance on to the pre-expanded ionomer material, soaking the pre-expanded ionomer material in a vaporisable substance, or the like, or a combination thereof. In some embodiments, it can be desirable to remove excess vaporisable substance from the surface of the pre-expanded ionomer material before subsequent treatment, e.g., prior to subsequent heating treatment.

In some embodiments, the vaporisable substance can include a polar aprotic liquid. The polar aprotic liquid can include at least one liquid selected from water, an alcohol, dimethylformamide, dimethylsulfoxide, acetonitrile, and the like. In some embodiments, the polar aprotic liquid can include a dipolar aprotic liquid.

In some embodiments, heating the pre-expanded ionomer material to form voids can be accomplished by any convenient method that can transfer heat sufficiently rapidly and that can remove heat sufficiently rapidly when the void formation is accomplished. Examples of suitable methods include, for example, using heated air blown on to the pre-expanded ionomer material, rapid passage of the pre-expanded ionomer material through a hot zone in an oven followed by a cooling zone, transient exposure of the pre-expanded ionomer material to infrared radiation, or application of microwaves when water or other polar molecule that can absorb the microwave energy is present in the pre-expanded ionomer material.

In some embodiments, “rapid” means applying heat sufficient to vaporise the fluid in the pre-expanded ionomer material over a heating time of 0.01 seconds to 120 seconds, more preferably 1 second to 60 seconds, and most preferably 5 seconds to 30 seconds. These times should be understood to be exemplary. As will be apparent to those of ordinary skill in the art, heating time may vary from the times provided here depending upon the ionomer used, the amount of ionomer being heated, the fluid content and heating method chosen, and the like.

In addition to the heating being rapid enough to cause the formation of voids, in some embodiments, the heating method can be transient enough such that the chemical composition of the pre-expanded ionomer material is not substantially changed in an undesirable way and/or such that the voids do not collapse after their formation due to excessive softening or melting of the polymer material surrounding the voids. However, the latter phenomenon can also be used to regulate the size of the voids if desired. For example, in some embodiments, the heating can be applied for a controlled time such that a desired degree of collapse of the voids can occur post formation. The time and temperature of heating can be adjusted to achieve the desired degree of void collapse, and thus, the desired size of the void when the material is finally cooled. A cooling fluid, for example, water or other liquid or air or other gas, can be applied to the hot expanded material to assist in cooling the material quickly at the desired time.

In some embodiments, the size and number of the voids can be controlled by varying the vaporisable liquid content of the pre-expanded ionomer material, where higher liquid content can result in larger voids in the expanded ionomer material. Merely by way of example, if the vaporisable liquid includes water, one convenient method for varying the water content of a pre-expanded ionomer material is to expose it to an atmosphere with different humidity. For example, a higher humidity atmosphere can increase the liquid content of the pre-expanded ionomer material, and a lower humidity atmosphere can decrease the liquid content of the pre-expanded ionomer. Thus, to obtain a higher water content, the pre-expanded ionomer material can be brought into contact with liquid water, for example, dipping in liquid water, spraying with liquid water, or soaking in liquid water. Liquids other than water can also be used in the methods disclosed herein. In some embodiments, it can be desirable to remove excess liquid from the surface of the pre-expanded ionomer material before heat treatment.

In some embodiments, the voids within the expanded ionomer material can include spheroids with diameters in the range of 10 microns to 100 microns. In some embodiments, the voids can include spheroids with diameters larger than 100 microns, or 150 microns, or 200 microns, or 250 microns, or 300 microns. In some embodiments, the voids can include spheroids with diameters smaller than 10 microns. The voids can have shapes other than spheroids. In some embodiments, the porosity of the expanded ionomer material is higher than the porosity of the ionomer (i.e., native, untreated ionomer) by at least 5%, or at least 10%, or at least 20%, or at least 30%, or at least 40%. In some embodiments, the porosity of the expanded ionomer material is at least 20%, or at least 30%, or at least 40%, or at least 50%, or at least 60%, or at least 70%, or at least 80%. The increase in the porosity of the expanded ionomer material can be due to the expansion of the native, untreated ionomer.

The methods disclosed herein can further include depositing a modifying component within at least some of the voids. The modifying component can include a material selected from, for example, silica, a solid acid, a catalytic material, and the like. The solid acid can include, for example, a zirconium phosphate, or the like. The catalytic material can include, for example, a metal, a metal oxide, or the like. The metal can include a metal selected from, for example, platinum, palladium, ruthenium, iridium, copper, nickel, and the like. The metal oxide can include a material selected from, for example, titania, alumina, zirconia, and the like. The modifying component(s) can be deposited in at least some of the voids by any suitable method where the solid is formed in situ in the voids or can be made to migrate to the voids. An exemplary method is by precipitation or other reaction where initially soluble species (modifying component(s)) are brought together within the voids to form a solid deposit of the modifying component(s).

The expanded ionomer material can have a configuration selected from, for example, a block, a sheet, a bead, a pellet, a powder, or the like. The method can include processing the expanded ionomer material into one of these configurations. Merely by way of example, the method can further include producing a powder using the expanded ionomer material. In some embodiments, producing of the powder can include using mechanical grinding. In some embodiments, mechanical grinding can include, for example, using a blade grinder, a ball mill, or the like, or a combination thereof.

Once expanded, the expanded ionomer material can be further processed if desired. For example, pellets of the ionomer that have been expanded can be ground into powders using conventional techniques such as mechanical grinding. For example, a blade mill, a ball mill, or the like, or a combination thereof, can be used to conveniently produce the powder. One advantage of the decreased toughness of the expanded ionomer is that the ball mill can be operated without cryogenic cooling, however cryogenic cooling can be used if desired. In some embodiments, a conventional blade grinder intended to grind coffee beans can be a suitable device for producing powder from expanded ionomer material. The distribution of sizes of the powder particles produced can be controlled by the grinding time used, with longer grinding times leading to smaller particle sizes on average. After grinding, the powders can be further used as they are or after being cleaned, for example by washing the powder with a wash agent. The wash agent, e.g., acid, base, water, or the like, or a combination thereof, can be selected based on the ionomer being used. As an example, for Nafion®, a hot nitric acid wash followed by a water wash can be used. Such post formation treatments, e.g., cleaning using a wash agent, can be used on other configurations (e.g., a block, a sheet, a bead, a pellet, or the like) of the expanded ionomer material.

Once produced, the expanded ionomer powder can be used in that form or further processed. For example, if it is desired to deposit other material(s) (modifying component(s)) into the voids in the expanded ionomer, then this can be conveniently performed on the powder. In some embodiments, the expanded ionomer powder, with or without additional substance(s) (modifying component(s)) deposited in its voids, can be further processed to form other structures. For example, the powder can be placed as a layer in a press and sintered or melted to form a membrane. In some embodiments, the powder can also be formed into any desired shape and then sintered to form a monolithic structure. For example the powder can be formed into a block, which can be subsequently sintered sufficiently to join the particles of powder together but to leave open space between the particles, such as in conventional sintered porous structures. The resulting macroporous block can be conveniently used as catalytically active structure, through which liquid or gas can be passed to catalyse a desired chemical reaction. The monolithic structure means that the catalyst is easy to recover and handle while providing high surface area for reactions to take place and providing desirable flow properties that prevent or reduce catalyst bypass in flow reactors. In some embodiments, the macroporous block can be useful in applications such as fuel cells and electrolysers as described in PCT Application No. PCT/IB2011/055924 entitled FUEL CELL AND ELECTROLYSER STRUCTURE, which is hereby incorporated by reference in its entirety. The formed membrane can be used in a similar way as the macroporous block in fuel cells, electrolysers, catalytically active structure, or the like.

Some embodiments of the invention include a method of using the expanded ionomer material. Merely by way of example, the created voids within the expanded ionomer material can be filled with water to increase the resistance to the ionomer drying out. This can be useful in applications where high ion conductivity is desired, as a high ionomer water content can increase ion conductivity through the material. One or more materials (modifying components) can be deposited within the voids of the expanded ionomer material to enhance the functional properties of the composite material. For example, the deposited material (modifying component) can be silica, which is hygroscopic and thus can help retain water within the expanded ionomer material. In some embodiments, the deposited material (modifying components) can be a solid acid, such as a zirconium phosphate, which can increase the concentration of fixed and mobile ions in the material. In some embodiments, an expanded ionomer material including voids in the form of a membrane or sheet, with or without one or more deposited modifying components, can be useful in applications such as fuel cells and electrolysers as described in PCT Application No. PCT/IB2011/055924 entitled FUEL CELL AND ELECTROLYSER STRUCTURE, which is hereby incorporated by reference in its entirety. In some embodiments, an expanded ionomer is used as a catalytically active structure. One or more catalysts can be deposited within the voids of the expanded ionomer material. The deposited modifying component(s) can have a catalytic surface for carrying out chemical reactions. Examples of catalytic materials include, for example, a metal such as platinum, palladium, ruthenium, iridium, copper, nickel, or the like, a metal oxide such as titania, alumina, zirconia, and one or more other solid materials (modifying components) with the desired catalytic properties.

### EXAMPLES

The following non-limiting examples are provided to further illustrate embodiments of the invention described herein. It should be appreciated by those of skill in the art that the techniques disclosed in the examples that follow represent approaches discovered by the inventors to function well in the practice of the application, and thus can be considered to constitute examples of modes for its practice. However, those of skill in the art should, in light of the instant disclosure, appreciate that many changes can be made in the specific embodiments that are disclosed and still obtain a like or similar result without departing from the spirit and scope of the application.

### Example 1

A sample of Nafion® N117 membrane (pre-expanded ionomer material) was placed in a domestic 850 W microwave oven for 15 seconds on full power setting. After heat treatment, the membrane had expanded and changed from the original transparent film into an opaque, expanded layer that was white in colour. The expanded sample was examined under a Mitutoyo travelling microscope with back lighting. Under magnification, a plurality of spherical voids had formed within the membrane throughout its thickness and the range of void sizes visible under the microscope was estimated. The smallest visible voids had diameters of about 15 to 30 microns. The largest voids commonly visible were about 100 microns in diameter. There could be voids smaller than 15 microns also present, as areas of the membrane where individual voids were not readily visible at the degree of magnification being used appeared grey in colour, indicating that light was being scattered from these areas.

### Example 2

Nafion® NR50 pellets (pre-expanded ionomer materials) were placed in a domestic 850 W microwave oven for 15 seconds on full power setting. After heat treatment, the pellets had expanded and changed from the original translucent pellet into an opaque, expanded pellet that was white in colour. Under a light microscope, a plurality of voids in the expanded pellet were visible that scattered the light, thus causing the opacity and white colour. The heat-treated (expanded) pellets were then put in a domestic coffee bean grinder and ground for three minutes in six, thirty-second bursts. This mechanical grinding treatment reduced the expanded pellets to a fine powder with particle sizes ranging from 10 microns to 300 microns.

### Example 3

A square of Nafion® N117 membrane (pre-expanded ionomer material) weighing 0.0637 g was placed in a domestic 850 W microwave oven for 15 seconds on full power setting. This caused the sample of membrane to expand and become opaque. After heat treatment, the weight of the sample reduced to 0.0630 g. A possible explanation for the reduction in weight could be the loss of water from the sample.

This sample (expanded ionomer material) and a reference sample of untreated Nafion® N117 (pre-expanded ionomer material) of similar size were then placed in 35% nitric acid at approximately 90° C. for 20 minutes to clean them and ensure they were both fully converted to the acid form. The samples were then rinsed with water and placed in boiling ultrapure water for a further 20 minutes to remove any excess acid. The heat treated (expanded) sample maintained its expanded structure throughout these treatments.

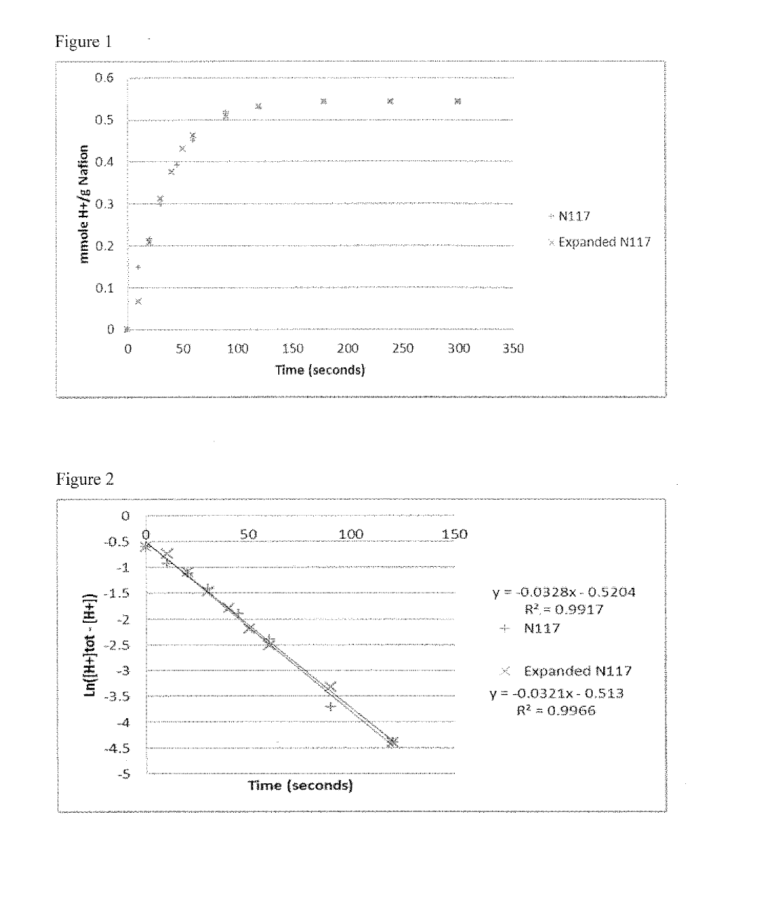

The ion exchange capacity and the ion exchange kinetics of the expanded and untreated samples (pre-expanded ionomer materials) were measured at room temperature by placing each of the samples in 20 ml of a 0.1 M solution of sodium chloride and using a glass pH electrode to monitor the change in pH of the solution with time as the protons in the Nafion® were exchanged for sodium ions, such that the protons entered the solution and lowered its pH. A glass pH electrode was placed in the 0.1 M sodium chloride solution and the pH allowed to stabilize. The Nafion® sample was then added to the solution and this point taken to be time zero. The change in pH over time was used together with the volume of sodium chloride solution to calculate the moles of protons exiting the Nafion®. The number of moles was divided by the weight of the Nafion® sample being tested to give the moles of protons per gram of Nafion® exchanged over time. A plot of this data is shown in FIG. 1. The data for both samples fall on the same line indicating no significant change in either the kinetics of sodium/proton exchange or total ion exchange capacity. FIG. 2 is a plot of the natural logarithm of the initial amount of protons present (as represented by the plateau amount) minus the amount of protons that had exited at time t. The plots overlay one another and demonstrate first order ion exchange kinetics in proton concentration. The total exchange capacity of the two samples can be expressed as the equivalent weight, that is, the grams of Nafion® per moles of exchangeable monovalent cations. Note that for the heat-treated sample the original weight of the partially hydrated Nafion® sample, before heat treatment, was used to give a more direct comparison between the untreated (pre-expanded) and heated treated (expanded) sample. The equivalent weight of the pre-expanded N117 sample was 1844 g/mol and that of the expanded material was 1841 g/mol. In FIG. 1 and FIG. 2, +'s denote data for pre-expanded Nafion® N117 (“N117”), and x's denote data for heat treated (expanded) Nafion® N117 (“Expanded N117”).

### Example 4

Two pellets of Nafion® NR50 (pre-expanded ionomer materials) were put into an 850 W domestic microwave oven on full power for 23 seconds, and then immediately removed and quenched by immersion in water at room temperature. In the oven the pellets expanded and became white in colour and opaque. The expanded pellets and untreated (pre-expanded) Nafion® NR50 pellets were put in 35% nitric acid solution with heating and stirring for 30 minutes. At the end of the 30 minutes the expanded pellets were not wetted but floated on top of the liquid whereas the untreated (pre-expanded) pellets sat at the bottom of the liquid. The acid was decanted off the pellets and the pellets squirted with water to rinse them. In this squirting process, the expanded pellets absorbed the water and became denser, resulting in them sinking to the bottom of the water in the container.

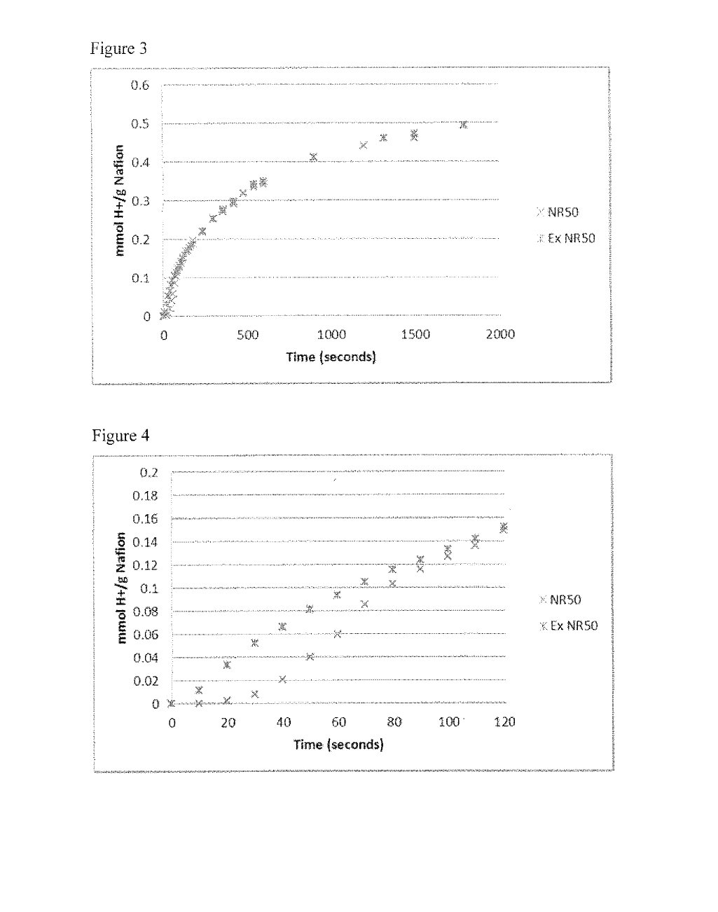

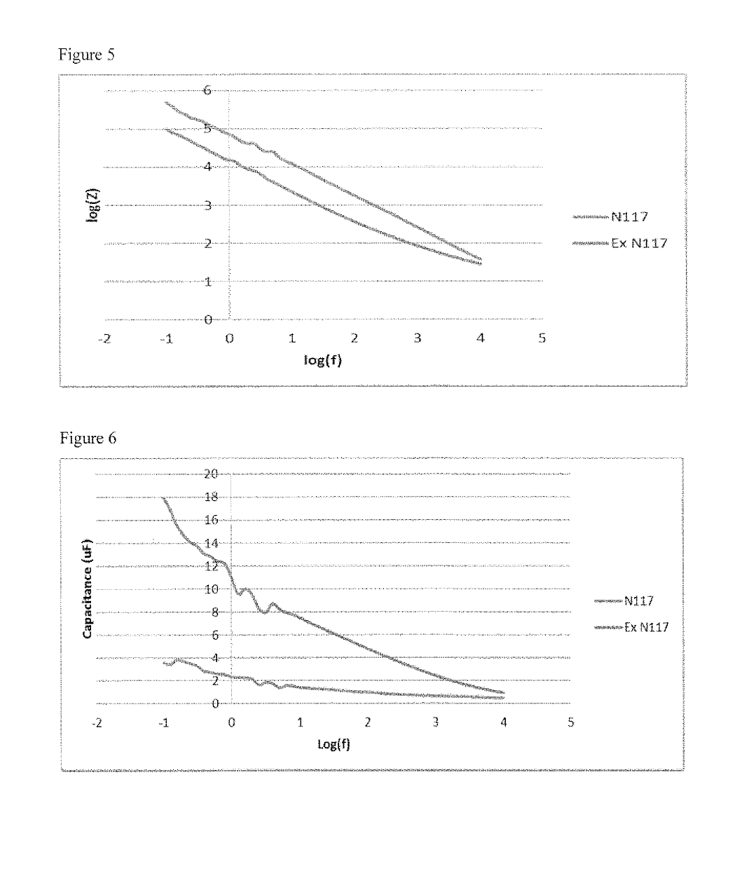

The expanded and pre-expanded pellets were further rinsed with 5 changes of ultrapure water and then washed in boiling ultrapure water with stirring for approximately one hour. An ion exchange experiment as per Example 3 was then performed on the expanded and pre-expanded samples. The results are shown in FIGS. 3 and 4. In FIGS. 3 and 4, x's denote data for pre-expanded Nafion® NR50 (“NR50”), and *'s denote data for expanded Nafion® NR50 (“Ex NR50”). FIG. 3 displays the data gathered over the entire period the ion exchange was measured. FIG. 4 displays the data at short time periods, so as to be able to examine the initial behaviour in more detail. FIG. 3 demonstrates that in an overall sense the ion exchange kinetics for both the pre-expanded and expanded NR50 pellets is very similar. However FIG. 4 demonstrates that the two material forms did behave differently initially. The pre-expanded sample displayed a 30-second lag in the appearance of protons in the solution whereas there was no significant lag observed for the expanded NR50 pellets. The two curves do not converge until 120 seconds. This is consistent with there being a higher concentration of readily accessible ion exchange sites near the surface of the expanded NR50 compared to the pre-expanded NR50.

### Example 5

A sample of Nafion® N117 membrane (pre-expanded ionomer material) was placed on a stainless steel wire mesh and heated with a hot air gun (Ryobi CPS2000VK 2000 Watt variable speed heat gun) for 10 seconds. This heat treatment caused the N117 to expand and become opaque with multiple voids apparent under the microscope. This expanded sample and a reference sample of pre-expanded Nafion® N117 of similar size were placed in 35% nitric acid at approximately 90° C. for 20 minutes to clean them and ensure they were both fully converted to the acid form. The samples were then rinsed with water and placed in boiling ultrapure water for 15 minutes to remove any excess acid. A rectangular sample of the same size (7 mm×4 mm) was cut from each of the expanded sample and reference sample (pre-expanded ionomer material). The samples were stored in water until they were tested to ensure they were fully hydrated. For testing each sample was clamped between stainless steel plates, where the area of each stainless steel plate was 7 mm×3.5 mm and fully covered by the membrane, and the assembly placed in a closed tube with water in the base of the tube, but not in contact with the test assembly, to ensure a humid environment in the tube.

An Autolab PGST30 with a Frequency Response Analysis (FRA) module was used to record the impedance spectrum of the two samples between 0.1 Hz and 10 kHz using a 10 mV AC signal at room temperature. A plot of the log of the impedance and the capacitance versus the log of the frequency for the two samples is given in FIGS. 5 and 6, respectively. The impedance of both samples was similar at 10 kHz; however, the impedance of the expanded N117 was about an order of magnitude lower than that of the pre-expanded sample at 0.1 Hz. FIG. 6 shows that this drop in impedance was due to a dramatic increase in the capacitance of the expanded sample at low frequencies compared to the pre-expanded sample. In pre-expanded Nafion®, the interface limiting the measured capacitance can be where the polymer bound sulphonate groups form the mobile ionic species that balances the net positive charge in the electronic conductor. Since these charged groups can have lower mobility than ions in a typical salt solution, the capacitance at the pre-expanded Nafion® conductor interface can be lower than for a typical salt solution, for example, at high frequency. This is consistent with what was measured for the pre-expanded N117, which corresponded to a capacitance per square area of 1.7 uF/cm̂2 at 10 kHz and 12.8 uF/cm̂2 at 0.1 Hz, which was comparable to typical values for salt solutions of 10 to 40 uF/cm̂2. The increase in capacitance at lower frequency is not unexpected, as it can reflect the time taken for the polymer chains of the pre-expanded Nafion® to reorient such that the sulphonate groups can approach the surface of the electronic conductor. For the expanded N117 the measured capacitance per square area was 3.3 microfarad per square centimetre of the sample surface area (uF/cm̂2) at 10 kHz and 64.1 uF/cm̂2 at 0.1 Hz. The observed large capacitance at low frequency for the expanded N117 was beyond the range typically expected for a salt solution, but consistent with the ion exchange data in Example 4, which indicated a higher concentration of surface accessible sulphonate groups compared to pre-expanded Nafion®. The observed frequency dependence of the capacitance for the two N117 forms further indicated increased polymer chain mobility, at least at the surface, for the expanded N117 compared to the pre-expanded sample.

### Example 6

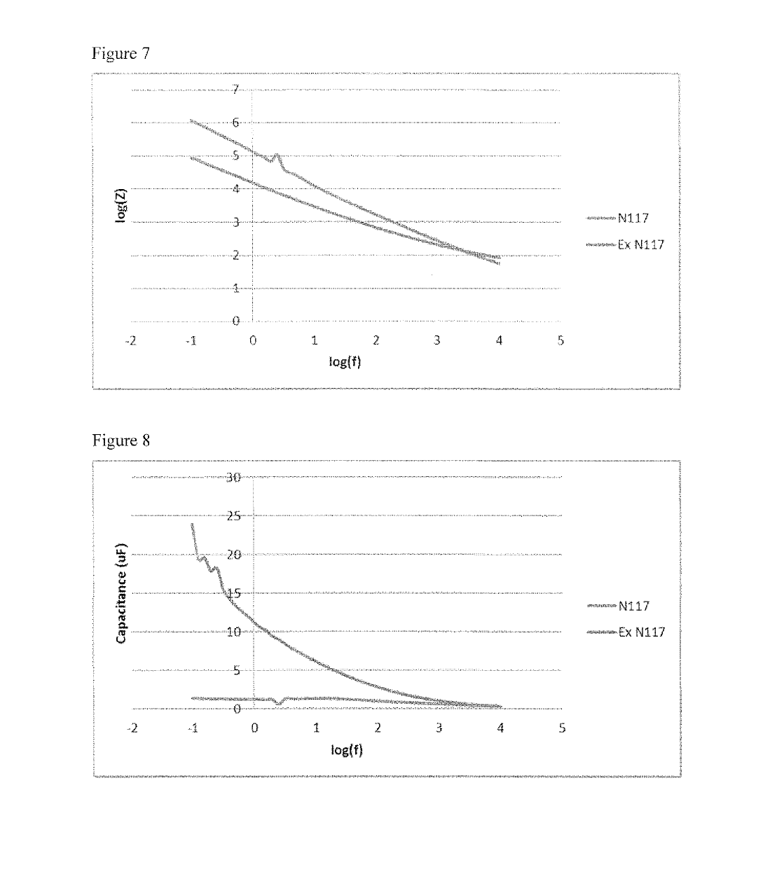

Rectangular pieces of pre-expanded N117 and expanded N117 (7 mm by 4 mm) were cut from the samples used in Example 3, which were in the sodium form. The test procedure used in Example 5 was used with these samples to measure the impedance spectrum. The results are shown in FIGS. 7 and 8. They were similar to the results for the samples in the acid form; however, the impedance for sodium form samples at 10 kHz was somewhat higher, reflecting the decreased mobility of the sodium ions in the Nafion compared to protons. As with the acid form samples, the impedance at 0.1 Hz was about an order of magnitude lower for the expanded N117 compared to the pre-expanded N117, and the expanded N117 showed a much larger capacitance frequency dependence. In this experiment the capacitance per unit area increased from 1.2 uF/cm̂2 at 10 kHz to 5.0 uF/cm̂2 at 0.1 Hz for the untreated (pre-expanded) N117, and from 1.2 uF/cm̂2 at 10 kHz to 85.5 uF/cm̂2 at 0.1 Hz for the expanded N117. Again, the magnitude of the capacitance at low frequency for the expanded N117 was large.

### Example 7

A rectangle of pre-expanded N117 was sandwiched between two stainless steel meshes and heated with hot air from a hot air gun (as per used in Example 5) for 10 seconds until the N117 expanded. Sandwiching the N117 between the meshes had the advantage of maintaining the flatness of the sample during the heating and expansion process. A 7 mm×4 mm rectangular piece was cut from this expanded N117. A similar sized piece of pre-expanded N117 was cut from the same N117 sheet that the sample that was heat treated was taken from. The sample that was subsequently heat treated and the sample that was not were taken from adjacent positions on the N117 sheet to attempt to minimize any differences between their properties. The samples were in the acid form and heated in water to hydrate them. These samples were used to evaluate the drying out behaviour of the native hydrated N117 compared to the expanded and hydrated N117. To do this, a sample was taken from its storage in water, dabbed dry with a tissue to remove excess surface water and sandwiched between stainless steel plates as in Example 5, however in this case the test assembly was mounted in a dry tube.

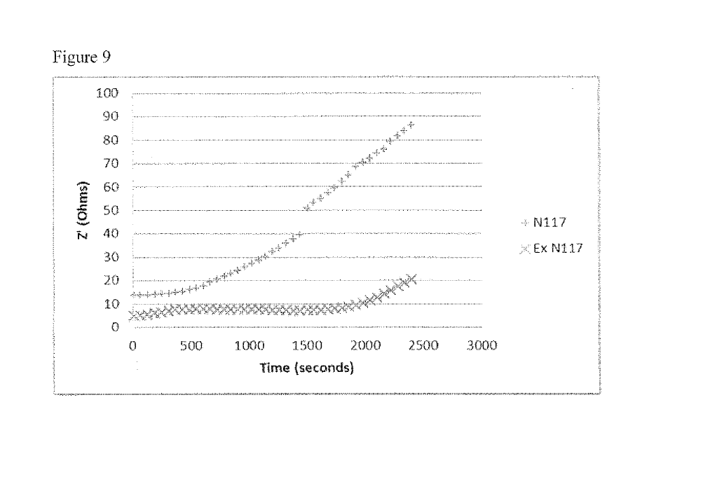

An Autolab PGST30 with FRA module was used to record the impedance every 60 seconds for 2400 seconds (40 minutes) using a 1 MHz, 10 mV AC signal. Time zero was taken when the potentiostat measurement was initiated, which was within 30 seconds of the sample being removed from water. The conditions in the laboratory when the test was conducted were a temperature in the range 22 to 23° C. and humidity in the range 32 to 35% RH. FIG. 9 displays the results of this experiment. The +'s indicate data for the pre-expanded N117 (“N117”) and the x's data for the heat treated (expanded) N117 (“Ex N117”). The initial resistance was 13.3 Ohm for the untreated (pre-expanded) N117 and 4.9 Ohm for the heat treated (expanded) N117, a 2.7 fold decrease in the resistance after heat treatment, in the initially hydrated state. The resistance of the pre-expanded N117 sample began to rise sharply after about 500 seconds and rose up to 85.9 Ohms at 40 minutes. In contrast, the resistance of the heat treated (expanded) sample of N117 stayed below 8 Ohms for 29 minutes and only rose to 20.3 Ohms at 40 minutes. This difference can be due, at least in part, to the increased water content of the expanded sample which can make it more resistant to drying out than the pre-expanded sample.

### Example 8

A rectangle of N117 (pre-expanded ionomer material) was sandwiched between two stainless steel meshes and heated with hot air from a hot air gun (as per that used in Example 5) for approximately 10 seconds until the N117 expanded. The expanded sample was washed with 35% nitric acid at approximately 90° C. for one and a half hours then boiled in ultrapure water to wash out the excess acid for approximately one hour. The washed sample was then cut into 6 pieces that were 4 to 5 mm wide by 9 mm long, with each piece weighing approximately 0.014 g. Each piece of expanded N117 was put into a tube containing 1 ml of either 0, 0.01, 0.1, 0.2, 0.5 or 1 M ZrOCl₂.8H₂O (zirconium oxychloride) in water. After one and a half hours, the expanded N117 pieces were removed from the solution, any excess liquid removed from the surface, and each piece put into 1 ml of 1 M H₃PO₄ and left overnight. The next morning the pieces were removed from the acid, rinsed with water and stored in water until tested. The pieces that had been soaked in solutions containing ZrOCl₂ were white even when well wetted, indicating the successful incorporation of zirconium phosphate, whereas the control piece of expanded N117 that had not been exposed to ZrOCl₂ was translucent. The impedance was measured using the same Autolab PGST30 with the FRA module as in Example 5 at 50 kHz and 0.1 Hz frequency. The results are summarized in the table below. These show some variation but generally a lower impedance when the zirconium phosphate is present in the expanded N117.

TABLE 1
Impedance of expanded N117 with or without zirconium
phosphate treatment

| ZrOCl₂ Soaking Solution | Z(50 kHz) | Z(0.1 Hz) |
|---|---|---|
| Concentration (Molar) | (Ohm) | (kOhm) |
| 0 | 8.2 | 568 |
| 0.01 | 10.2 | 239 |
| 0.1 | 6.4 | 259 |
| 0.2 | 5.5 | 118 |
| 0.5 | 7.5 | 141 |
| 1 | 5.0 | 117 |

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1. An expanded ionomer material comprising an ionomer and a plurality of voids, wherein a porosity of the expanded ionomer material is higher than a porosity of the pre-expanded ionomer material, and where the said voids were created upon the application of heat to the pre-expanded ionomer material.

2. The expanded ionomer material of claim 1, wherein the ionomer comprises at least one polymer selected from sulphonated polystyrene, carboxylated polystyrene, amminated polystyrene, a sulphonated fluoropolymer, carboxylated fluoropolymer, and amminated fluoropolymer.

3. The expanded ionomer material of claim 1, wherein the voids comprise spheroids with diameters in the range of 10 microns to 100 microns.

4. (canceled)

5. (canceled)

6. The expanded ionomer material of claim 1, wherein at least some of the voids contain a modifying component.

7. The expanded ionomer material of claim 6, wherein the modifying component comprises at least one material selected from silica, a solid acid, a catalytic material.

8. (canceled)

9. The expanded ionomer material of claim 7, wherein the catalytic material comprises a metal or a metal oxide.

10. (canceled)

11. (canceled)

12. The expanded ionomer material of claim 1, having a configuration selected from a block, a sheet, a pellet, a bead, and a powder.

13. A method for modifying an ionomer comprising:
providing an ionomer in a solid state;
contacting the ionomer with an impregnating substance to form a pre-expanded ionomer material; and
heating the pre-expanded ionomer material to expand the impregnating substance to create voids in the ionomer material thereby producing an expanded ionomer material.

14. The method of claim 13, wherein the ionomer comprises at least one polymer selected from sulphonated polystyrene, carboxylated polystyrene, amminated polystyrene, a sulphonated fluoropolymer, carboxylated fluoropolymer, and amminated fluoropolymer.

15. The method of claim 13, wherein the contacting the ionomer with the impregnating substance comprises storing the ionomer in air comprising water vapor.

16. The method of claim 13, wherein the impregnating substance comprises a polar liquid or vapor, or a dipolar aprotic liquid or vapor.

17. (canceled)

18. (canceled)

19. The method of claim 13, wherein the heating comprises at least one mechanism comprising blowing heated air on to the pre-expanded material, passing the pre-expanded material through a hot zone in an oven, exposing the pre-expanded material to infrared radiation, and applying microwave energy to the pre-expanded material.

20. The method of claim 13, wherein the voids comprise spheroids with diameters in the range of 10 microns to 100 microns.

21. (canceled)

22. (canceled)

23. The method of claim 13, further comprising depositing a modifying component within at least some of the voids.

24. The method of claim 23, wherein the modifying component comprises at least one material selected from silica, a solid acid, a catalytic material.

25. (canceled)

26. The method of claim 24, wherein the catalytic material comprises a metal or a metal oxide.

27. (canceled)

28. (canceled)

29. (canceled)

30. The method of claim 13 further comprising processing the expanded ionomer material to form a configuration selected from a block, a sheet, a pellet, a bead, and a powder.

31. (canceled)

32. (canceled)

33. The method of claim 30, wherein the processing the expanded ionomer material comprises grinding to produce powder.

34. (canceled)

35. (canceled)

36. (canceled)

37. The method of claim 30, wherein the processing the expanded ionomer material comprises sintering to form a sintered structure.

38. The method of claim 33, wherein the processing the expanded ionomer material further comprises sintering to form a sintered structure.
